(19) United States
(12) Patent Application Publication
(10) Pub. No.: US 2021/0183187 A1
(43) Pub. Date: Jun. 17, 2021

(54) VEHICLE DRIVING CONDITION EVALUATION METHOD AND SYSTEM

(71) Applicant: TOYO TIRE CORPORATION, Itami-shi (JP)

(72) Inventor: Naoki Isayama, Itami-shi (JP)

(73) Assignee: TOYO TIRE CORPORATION, Itami-shi (JP)

(21) Appl. No.: 17/110,679

(22) Filed: Dec. 3, 2020

(30) Foreign Application Priority Data
Dec. 11, 2019 (JP) 2019-223865

(51) Int. Cl. G07C 5/08; G07C 5/00; G01C 21/00

(52) U.S. Cl. CPC G07C 5/0841; G07C 5/008; G01C 21/3807; G01C 21/3885; G01C 21/3848

(57) ABSTRACT

A vehicle driving condition evaluation method includes: dividing map information into a plurality of section areas; acquiring a plurality of pieces of position information and travel information of a vehicle in association with each other; storing the plurality of pieces of acquired position information and travel information; calculating a plurality of index values related to a driving severity number for each of the section areas based on the plurality of pieces of stored position information and travel information; averaging the plurality of index values for each of the section areas; and identifiably displaying an averaged index value as the driving severity number on a map displayed on a screen. Weighting is performed on each of the plurality of index values according to a driving condition in averaging the plurality of index values for each of the section areas.

### CROSS-REFERENCE TO RELATED APPLICATIONS

This application claims priority of Japanese Patent Application No.: 2019-223865 filed on Dec. 11, 2019, the content of which is incorporated herein by reference.

### BACKGROUND OF THE INVENTION

### Technical Field

The present invention relates to a vehicle driving condition evaluation method and system.

### Related Art

A wear resistance performance evaluation method is known in which the acceleration of a vehicle is measured and a driving severity number (DSN) is calculated as a tire wear resistance performance evaluation index from the measured acceleration (see, for example, JP 2010-204095 A).

However, JP 2010-204095 A takes only acceleration into consideration as the driving severity number. Moreover, how the driving severity number changes depending on the driving route of the vehicle is not taken into consideration. Furthermore, driving conditions are not taken into consideration. All the measured accelerations are handled uniformly regardless of the driving conditions, which fails to provide highly accurate evaluation according to such driving conditions as driving distance, vehicle information, and tire information.

### SUMMARY

An object of the present invention is to improve evaluation accuracy and visualize the driving severity number by evaluating the driving severity number according to the driving route and driving conditions of the vehicle in the vehicle driving condition evaluation method and system.

A first aspect of the present invention provides a vehicle driving condition evaluation method including: dividing map information into a plurality of section areas; acquiring a plurality of pieces of position information and travel information of a vehicle in association with each other; storing the plurality of pieces of acquired position information and travel information; calculating a plurality of index values related to a driving severity number for each of the section areas, based on the plurality of pieces of stored position information and travel information; averaging the plurality of index values for each of the section areas; and identifiably displaying an averaged index value as the driving severity number on a map displayed on a screen, in which weighting is performed on each of the plurality of index values according to a driving condition in averaging the plurality of index values for each of the section areas.

With this method, it is possible to identifiably display the average of a plurality of index values calculated based on a plurality of pieces of position information and travel information, as the driving severity number for each section area on the map. As a result, the driving severity number can be grasped at a glance for each section area. The obtained information can be used for various purposes such as estimation of the wear state of a tire. The travel information indicates general information obtained when the vehicle is traveling, and includes, for example, the acceleration, speed, azimuth, and the like of the vehicle. The driving condition refers to a condition that can affect the travel information, and includes, for example, driving distance, vehicle information, tire information, and the like as described later. In the method described above, the data value of the index value satisfying a specific driving condition can be increased by weighting each of a plurality of index values according to the driving condition in averaging the index values. Thus, the evaluation accuracy can be improved, and the driving severity number can be visualized by evaluating the driving severity number, according to the driving route and the driving condition of the vehicle.

The driving condition for performing the weighting may include the driving distance.

With this method, the driving distance can be taken into consideration as a driving condition. The consideration of the driving distance is, for example, weighted so that the value of the index values of the travel information that has traveled a relatively long distance becomes high. This is because the travel information that has traveled a relatively long distance is highly reliable as data.

The driving condition for performing the weighting may include the vehicle information.

With this method, the vehicle information can be taken into consideration as a driving condition. The vehicle information includes vehicle manufacturer, vehicle type, vehicle name, engine type, and the like. The weighting may be performed, for example, such that the value of the index value of the travel information acquired by using the vehicle information with many vehicles sold becomes high. In this manner, the main layer of the market can be advantageously evaluated, which enables evaluation in line with the market.

The driving condition for performing the weighting may include the tire information.

With this method, the tire information can be taken into consideration as a driving condition. The tire information includes tire manufacturer, tire name, tire type, tire width, flattening, rim diameter, road index, speed symbol, air pressure, and the like. The weighting may be performed, for example, such that the value of the index value of the travel information acquired by using the tire information with many tires sold becomes high. In this manner, the main layer of the market can be advantageously evaluated, which enables evaluation in line with the market.

The position information and the travel information may be acquired from a mobile device installed in the vehicle.

With this method, it is not necessary to prepare a dedicated device for acquiring the position information and the travel information, and the position information and the travel information can be easily acquired. Examples of the mobile device may include a smartphone, a laptop computer, or any other portable terminal.

The mobile device may be a smartphone, and the position information may be acquired from both a satellite positioning system and a base station of the smartphone.

With this method, since the position information can be acquired from the base station of the smartphone even in places such as tunnels or underground, where the satellite positioning system is difficult to use, the accuracy of the acquired position information can be improved.

The plurality of index values may be corrected with environmental information of a place where the vehicle is located that is acquired by the smartphone over the Internet.

With this method, the driving severity number can be evaluated in consideration of the environmental information. The environmental information includes the temperature, humidity, weather, season, climate, and the like of a region in which the vehicle is located. Since the driving severity number is largely affected by such environmental information, it is useful to be able to take the environmental information into consideration in the evaluation of the driving severity number.

A second aspect of the present invention provides a vehicle driving condition evaluation system including: a receiving unit configured to detect position information of a vehicle; a measuring unit configured to measure travel information of the vehicle; a storage unit configured to store map information, a plurality of section areas obtained by dividing a map to be displayed on a screen based on the map information, and the position information and the travel information in association with each other; a display unit configured to display a map based on the map information stored in the storage unit; and a processing unit configured to calculate a plurality of index values, average the plurality of calculated index values for each of the section areas based on a plurality of pieces of the position information and the travel information stored in the storage unit, and cause an averaged index value to be identifiably displayed as a driving severity number on the map displayed on the display unit, in which the processing unit performs weighting on the plurality of index values according to a driving condition in averaging the index values for each of the section areas.

According to the present invention, it is possible to improve evaluation accuracy and visualize the driving severity number by evaluating the driving severity number according to the driving route and driving conditions of the vehicle in the vehicle driving condition evaluation method and system.

### BRIEF DESCRIPTION OF THE DRAWINGS

The foregoing and the other features of the present invention will become apparent from the following description and drawings of an illustrative embodiment of the invention in which:

FIG. 1 is a block diagram of a vehicle driving condition evaluation system according to an embodiment of the present invention;

FIG. 2 is a plan view illustrating a map displayed on a second display unit in FIG. 1;

FIG. 3 is a partially enlarged view of FIG. 2; and

FIG. 4 is a plan view illustrating FIG. 3 in a different manner.

### DETAILED DESCRIPTION OF EMBODIMENTS

Hereinafter, embodiments of the present invention will be described with reference to the accompanying drawings.

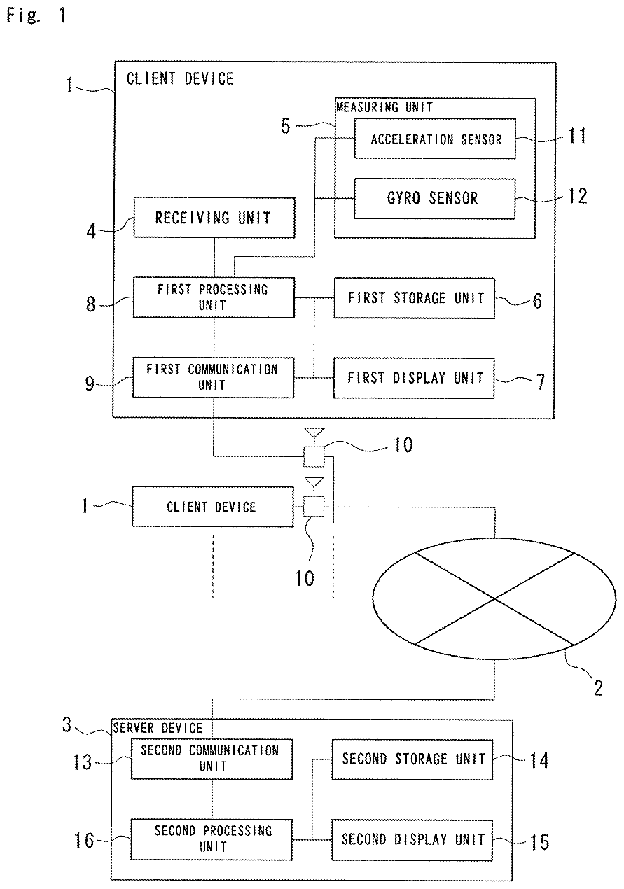

FIG. 1 illustrates a vehicle driving condition evaluation system according to the present embodiment. This system includes a client device 1 installed in each vehicle and a server device 3 connected via a communication network 2 such as the Internet.

The client device 1 may be, for example, a mobile device such as a smartphone, a laptop computer, or other portable terminals, or a dedicated device fixedly installed in a vehicle. In the present embodiment, the case where the client device 1 is a smartphone will be described below as an example.

The client device (smartphone) 1 is fixed horizontally with the head of the smartphone 1 facing the front of the vehicle in the vehicle so that the measured values of each sensor described later can be easily processed. However, the installation mode of the smartphone 1 is not limited to this. Even when the smartphone 1 is tilted and fixed from the front of the vehicle or from the horizontal direction, accurate measured values can be obtained by correcting the measured values of each sensor described later according to the tilt angle.

The smartphone 1 includes a receiving unit 4, a measuring unit 5, a first storage unit 6, a first display unit 7, a first processing unit 8, and a first communication unit 9.

The receiving unit 4 receives signals transmitted from satellites of a satellite positioning system, performs processing such as decoding of the received signals, and outputs the signals to the first processing unit 8. The satellite positioning system may be a global navigation satellite system or a regional satellite system, and the type thereof is not particularly limited. Examples of the satellite positioning system include the GPS (Global Positioning System), the GLONASS (Global Navigation Satellite System), the BNSS (BeiDou Navigation Satellite System), Galileo, the QZSS (Quasi-Zenith Satellite System), the NavIC (Navigation Indian Constellation), and DORIS (Doppler Orbitography and Radiopositioning Integrated by Satellite). Furthermore, the satellite positioning system may use a plurality of these systems in combination. The receiving unit 4 is for acquiring the position information of the vehicle. In addition, the speed and azimuth of the vehicle can be calculated based on a change in the position information. The speed and azimuth are calculated by the first processing unit 8. Furthermore, the smartphone 1 may be separately provided with a geomagnetic sensor capable of measuring the azimuth.

The measuring unit 5 includes an acceleration sensor 11 and a gyro sensor 12. The acceleration sensor 11 and the gyro sensor 12 may be mounted on a general smartphone.

The acceleration sensor 11 may be of any method such as a capacitance detection method, a piezoresistive method, and a heat detection method. The acceleration sensor 11 can measure acceleration in three orthogonal axial directions. In the present embodiment, since the smartphone 1 is fixed horizontally with its head facing the front of the vehicle in the vehicle, the three axial directions indicate the vehicle front-rear direction, the vehicle width direction, and the vehicle height direction.

The gyro sensor 12 is a sensor that detects the posture of the smartphone 1. In the present embodiment, the gyro sensor 12 measures angular velocities around the three axes described above. Furthermore, the azimuth can be corrected by a known method from the angular velocities measured by the gyro sensor 12. The azimuth is corrected by the first processing unit 8.

In the present embodiment, the acceleration, speed, and azimuth in the three axial directions are measured or calculated as described above, and are stored in the first storage unit 6 as travel information. The travel information refers to all the information obtained when the vehicle travels. The acceleration, speed, azimuth, and the like of the vehicle are examples of the travel information.

The first communication unit 9 is a part that connects to the communication network 2 via a base station 10 and acquires the environmental information of the place where the vehicle is located from the Internet. The environmental information includes temperature, humidity, weather, season, climate, and the like. Since a driving severity number is affected by such environmental information, the environmental information is taken into consideration in the evaluation of the driving severity number as described later in the present embodiment.

In the present embodiment, since the first communication unit 9 connects to the communication network 2 via the base station 10, the position information can be acquired not only from the satellite positioning system but also from the base station 10. For example, while position information is usually acquired by using the satellite positioning system via the receiving unit 4, the position information may be acquired from the base station 10 via the first communication unit 9 in places such as tunnels or underground, where the satellite positioning system is difficult to use.

The first storage unit 6 stores map information, position information, travel information, and environmental information, and is a non-volatile memory such as a hard disk device, a magneto-optical disk device, or a flash memory (read-only storage media such as a CD-ROM), a volatile memory such as a random access memory (RAM), or a combination of these.

The map information is stored in the first storage unit 6 in a state of being divided into a plurality of section areas in advance. Each of the section areas is not limited to a square, and various shapes such as a rectangle, a triangle, a hexagon, and an octagon that can be equally divided can be adopted. The section areas may each be, for example, a square with one side of 1 km, and this may be the minimum unit. Furthermore, the section areas are not limited to these shapes, but free shapes such as a cloud shape can be adopted. Furthermore, the section areas do not necessarily have the same shape, and can have a shape formed by a combination of various shapes. Furthermore, as will be described later, the first storage unit 6 stores the position information, the travel information, and the environmental information of the vehicle for each section area in association with each other as time-series data.

The first processing unit 8 includes a central processing unit (CPU) and is connected to the receiving unit 4, the measuring unit 5, the first storage unit 6, the first display unit 7, and the first communication unit 9.

The first processing unit 8 executes a program stored in the first storage unit 6 based on signals input from the receiving unit 4 and the first communication unit 9 (that is, the base station 10), and identifies the current position of the vehicle. The first processing unit 8 also causes the first display unit 7 to display the current position of the vehicle and a map of the surrounding area. Furthermore, the first processing unit 8 associates the current position of the vehicle with the travel information of the vehicle obtained by the measuring unit 5 and stores these pieces of information for each section area as time-series data in the first storage unit 6. In this process, environmental information such as weather and temperature is also associated with these pieces of information and stored as time-series data in the first storage unit 6. The information stored in the first storage unit 6 is automatically transmitted to the server device 3 via the first communication unit 9 after the vehicle finishes traveling.

The first display unit 7 is for displaying a map, a status display screen, an input screen, and the like, and is, for example, a touch panel display.

The map displayed on the first display unit 7 can be freely scaled up, scaled down, and moved.

Examples of the position information displayed on the status display screen displayed on the first display unit 7 include latitude, longitude, country, region, accuracy of position information (for example, distance estimated as an error), and which of the satellite positioning system or the base station 10 is used to estimate the position is displayed. Furthermore, for example, acceleration, speed, and azimuth along the three axes are displayed as travel information on the status display screen. In addition, the weather and temperature are displayed as environmental information on the status display screen. Furthermore, driving conditions may be displayed on the status display screen. The driving conditions mean conditions that can affect the travel information. In the present embodiment, the driving conditions include driving distance, vehicle information, and tire information. The driving distance is acquired based on the information from the satellite positioning system, and the vehicle information and the tire information are obtained by being input by the user as described later.

On the input screen displayed on the first display unit 7, for example, an input field for inputting the vehicle information, the tire information, and other information is displayed. The vehicle information includes vehicle manufacturer, vehicle type, vehicle name, engine type, and the like. The tire information includes tire manufacturer, tire name, tire type, tire width, flattening, rim diameter, road index, speed symbol, tire pressure, and the like. The other information includes the number of passengers. These input information can be input in the input field on the input screen by a selection method or a free input method. Furthermore, it is not always necessary to input all of these pieces of input information, and even if they are not input, the driving severity number can be evaluated.

The server device 3 includes a second communication unit 13, a second storage unit 14, a second display unit 15, and a second processing unit 16.

The second communication unit 13 receives the information transmitted from the first communication unit 9 of the smartphone 1 via the communication network 2. Furthermore, results obtained by executing a program as described later are transmitted to the first communication unit 9 of the smartphone 1 via the communication network 2.

The second storage unit 14 can have the same configuration as the first storage unit 6 of the smartphone 1. A computer program is stored in the second storage unit 14, and the position information, the travel information, and the environmental information of the vehicle transmitted from each smartphone 1 are stored in association with each other.

Similarly to the first display unit 7, the second display unit 15 is composed of, for example, a touch panel display and can display a map or the like. When a map is displayed, the map can be freely scaled up, scaled down, and moved also in the same manner.

The second processing unit 16 includes a CPU, and is connected to the second storage unit 14. Furthermore, the second processing unit 16 executes the following processing according to the program stored in the second storage unit 14.

The second storage unit 14 stores the position information, the travel information, and the environmental information of the vehicle transmitted from each smartphone 1. Based on these pieces of information stored in the second storage unit 14, a plurality of index values are calculated and averaged for each section area. Here, the travel information detected in units of section areas is indexed by root mean square (RMS).

In indexing based on speed among the travel information, the index values are calculated as follows. As the speed increases, the number of rotations of the tire increases, and thus running resistance RS increases. As the running resistance RS increases, friction energy E also increases accordingly. In other words, the friction energy E is calculated from driving distance D and slip ratio S by E=RS×D×S. Therefore, the calculated friction energy E is indexed by RMS. The index values thus obtained can be used to predict the wear amount of the tire. Since the wear amount of the tire increases in proportion to the magnitude of the friction energy E, the obtained index values can be regarded as the wear amount of the tire.

When indexing is performed based on the acceleration among the travel information, the detected acceleration is converted into the friction energy E per unit distance, and the obtained friction energy E is indexed by RMS. The index values thus obtained can be used to predict the wear amount of the tire. Since the wear amount of the tire increases in proportion to the magnitude of the friction energy, the obtained index values can be regarded as the wear amount of the tire. In this case as well, as in the case of the speed described above, the obtained index values can be regarded as the wear amount of the tire.

When the index values described above are calculated, all the index values are not uniformly averaged, but weighted according to the driving conditions. In the present embodiment, the driving distance, the vehicle information, and the tire information are taken into consideration as the driving conditions as described above.

The weighting according to the driving distance is performed such that the value of the index value of the travel information that has traveled a relatively long distance becomes high from the viewpoint of the reliability of measured data. In addition, the weighting may be performed such that the value of the index value of the travel information that has traveled a remarkably short driving distance or a remarkably long driving distance becomes low.

For example, it is assumed that data with the following index values is acquired in a certain section area: the index value of the travel information with a driving distance of 30 km is 0.8, the index value of the travel information with a driving distance of 50 km is 1, the index value of the travel information with a driving distance of 10 km is 0.9, and the index value of the travel information with a driving distance of 15 km is 0.7. In this case, as indicated in the following equation (1), an average index value Z1 in this section area is calculated by integrating coefficients according to the driving distance, and the index value Z1 is evaluated as the driving severity number in the section area.

$$\begin{matrix}[ Equation 1 ] & \\ Z 1 = \frac{30 \times 0.8 + 50 \times 1 + 10 \times 0.9 + 15 \times 0.7}{30 + 50 + 10 + 15} & ( 1 )\end{matrix} \qquad$$

The weighting according to the vehicle information is performed such that the value of the index value of the travel information acquired by using the vehicle information with many vehicles sold becomes high.

For example, in comparison of the number of vehicles sold by vehicle type in a certain market, it is assumed that 1.5 million units of sedans, 4 million units of sport utility vehicles (SUVs), and 500,000 units of minivans were sold. Furthermore, it is assumed that data with the following index values is acquired: the index value of the travel information of sedans is 0.8, the index value of the travel information of SUVs is 1, and the index value of the travel information of minivans is 0.9. In this case, as indicated in the following equation (2), an average index value Z2 in the section area is calculated by integrating coefficients according to the number of vehicles sold by vehicle type, and the index value Z2 is evaluated as the driving severity number in the section area.

$$\begin{matrix}[ Equation 2 ] & \\ Z 2 = \frac{150 \times 0.8 + 400 \times 1 + 50 \times 0.9}{150 + 400 + 50} & ( 2 )\end{matrix}$$

The weighting according to the tire information is performed such that the value of the index value of the travel information acquired by using the vehicle information with many vehicles sold becomes high.

For example, in comparison of the number of tires sold by tire type in a certain market, it is assumed that 40 million summer tires, 30 million winter tires, and 30 million all-season tires were sold. Furthermore, it is assumed that data with the following index values is acquired: the index value of the travel information of summer tires is 0.8, the index value of the travel information of winter tires is 1, and the index value of the travel information of all-season tires is 0.9. In this case, as indicated in the following equation (3), an average index value Z3 in the section area is calculated by integrating coefficients according to the number of tires sold by tire type, and the index value Z3 is evaluated as the driving severity number in the section area.

$$\begin{matrix}[ Equation 3 ] & \\ Z 3 = \frac{4000 \times 0.8 + 3000 \times 1 + 3000 \times 0.9}{4000 + 3000 + 3000} & ( 3 )\end{matrix}$$

The weighting based on the three driving conditions described above may be performed individually for each driving condition or in combination.

The above-described processing is not necessarily performed by the second processing unit 16, but can also be performed by the first processing unit 8. In this case, the results calculated by the first processing unit 8 may be used by the second processing unit 16.

The indexing of the obtained information is not limited to the one performed by RMS, and may be performed by the least squares method, standard deviation, or the like.

Furthermore, if the travel information is indexed as described above, the index values may be corrected based on the environmental information. That is, the obtained index values may be corrected by multiplying them by a correction coefficient determined from the environmental information. The index values can thus be set to values more suitable for predicting the wear amount of the tire. This correction may be made by the second processing unit 16.

In the correction of the index values based on the environmental information, for example, it can be estimated that the road surface becomes slippery when the weather is rainy, so that the tire wear will be reduced. It can also be estimated that the road surface becomes more slippery when the weather is snow, so that the tire wear will be further reduced. It is also known that the wear performance of the tire changes as the temperature changes. Therefore, the index values calculated from the travel information is corrected based on the obtained environmental information. For example, by determining a correction coefficient based on the relationship between the environmental information obtained in experiments and the like on a certain tire and the wear amount of the tire, it is possible to accurately estimate the index values (wear amount of the tire).

If the index value for each section area is calculated, corrected, and accumulated based on the travel information and the environmental information in this way, the weighted average for the index values for each set range is identifiably displayed as the driving severity number on the map displayed on the screen.

The set range can be freely changed. When the size of the set range is larger than that of a section area, it suffices if the weighted average of the index values of all the section areas included in the set range is further averaged.

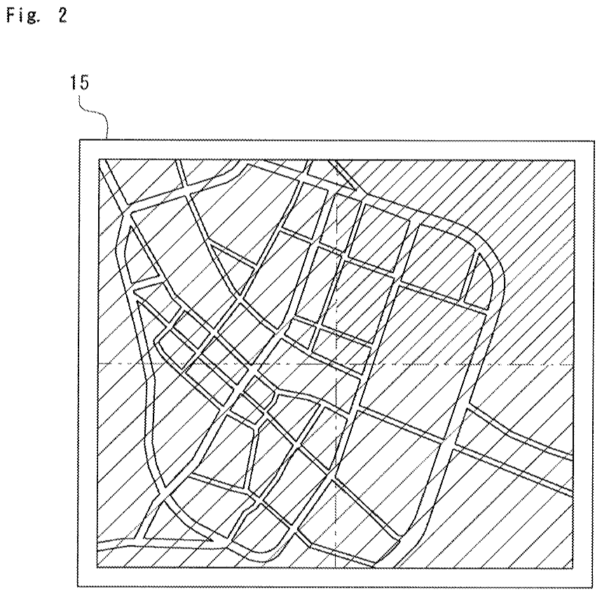

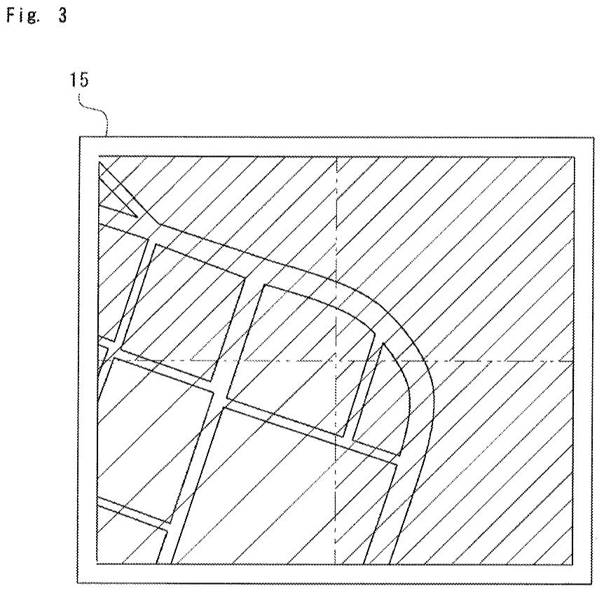

FIG. 2 is a wide-area map, and FIG. 3 is a detailed map partially enlarging FIG. 2. In the detailed map, the set range matches section areas. The driving severity number is identifiably displayed for each set range.

For example, in the range where the index values (specifically, the weighted average of the index values) are large, that is, the wear amount of the tire is determined to be large, the background color of the map can be set to “red”. The background color can be set to become lighter or another color as the index values decrease. When the background color becomes gradually lighter, the difference in the index values can be expressed as the difference in shade. When the background color is changed, a plurality of ranges are set depending on the difference in the index values (0 to 100, 100 to 200, and the like), and different colors are set for the respective ranges. In this context, the color displayed on the screen may be changed depending on which range the index value of each section area belongs to. In FIG. 3, the difference in the hatching intervals indicates a difference in the shade of the background color.

When the map is scaled down to display a wider area, the set range may be automatically enlarged. In this case, since the set range includes a plurality of section areas, the index values of all these section areas may be averaged. It is also possible to recalculate the index values from all the travel information within the set range. In FIG. 2, each set range contains a plurality of (four) section areas, and the driving severity number in the set range is identifiably displayed based on the weighted average of the index values of these section areas. In the set range with a narrow hatching interval, the shade of the background color is darker and the index values are large. A wider hatching interval indicates that the shade becomes lighter and the index values become smaller.

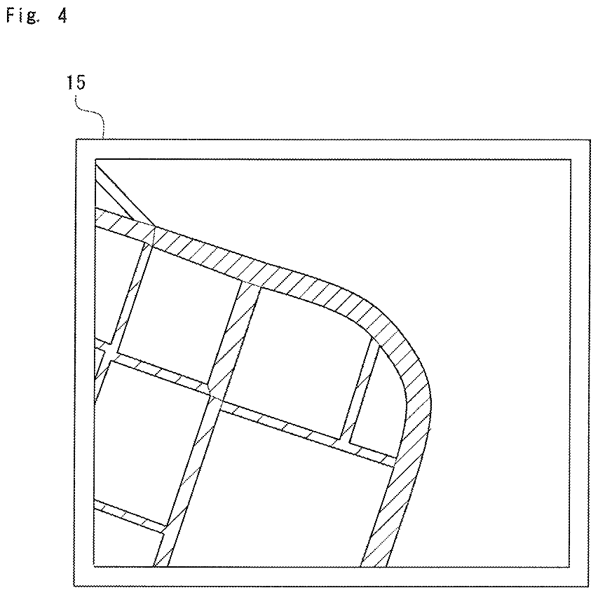

The identifiable display of the driving severity number on the map can be performed for each road. In FIG. 4, the driving severity number is identifiably displayed for each road. As described above, in this figure, the shade becomes darker as the hatching interval becomes narrower, indicating that the driving severity number increases.

The travel information and the environmental information stored in the second storage unit 14 may be managed on a country-by-country basis. By managing these pieces of information on a country-by-country basis, for example, road conditions (roughness of road surfaces, differences in road traffic laws, and the like) in each country can be taken into consideration. Since the environmental information varies greatly from country to country, wear state of a tire can vary greatly even if the vehicle speed and acceleration are the same. Therefore, the correction coefficient corresponding to the travel information may be different for each country. Furthermore, the map displayed on the screen may be displayed differently for each country.

A vehicle driving condition evaluation method using the above-described vehicle driving condition evaluation system will be described.

First, the user manually inputs the vehicle information, the tire information, and other information into the smartphone 1. Then, the smartphone 1 is horizontally fixed in the vehicle with the head of the smartphone 1 facing the front of the vehicle. In this state, the vehicle is actually driven to acquire the travel information and the environmental information.

While the vehicle is traveling, the position information, the travel information, and the environmental information are automatically recorded in the first storage unit 6 of the smartphone 1 in association with each other, and time-series data is accumulated.

When the vehicle finishes traveling, the recorded position information, travel information, and environmental information are automatically transmitted to the server device 3 in a state of being associated with each other, and are stored in the second storage unit 14. In the server device 3, index values related to driving severity number and correction values thereof are calculated based on the information stored in the second storage unit 14, and are stored in the second storage unit 14.

As the driving severity number of a specific section area, accumulated index values or correction values thereof are averaged after the above-described predetermined weighting, and the result is displayed on the second display unit 15. The user can confirm the driving severity number displayed on the second display unit 15 and use the obtained information for various purposes such as estimation of the wear state of the tire.

According to the present embodiment, it is possible to identifiably display the average of a plurality of index values calculated based on a plurality of pieces of position information and travel information, as the driving severity number for each section area on the map. As a result, the driving severity number can be grasped at a glance for each section area. The obtained information can be used for various purposes such as estimation of the wear state of a tire. In particular, in the present embodiment, the data value of the index value satisfying a specific driving condition can be increased by weighting each of a plurality of index values according to the driving conditions in averaging the index values. Thus, the evaluation accuracy can be improved, and the driving severity number can be visualized by evaluating the driving severity number, according to the driving route and the driving condition of the vehicle.

Since the driving distance is included in the driving conditions, the driving distance can be taken into consideration in evaluation of the driving severity number. The consideration of the driving distance is weighted so that the value of the index values of the travel information that has traveled a relatively long distance becomes high. This is because the travel information that has traveled a relatively long distance is highly reliable as data.

Since the vehicle information is included in the driving conditions, the vehicle information can be taken into consideration in evaluation of the driving severity number. In particular, the weighting is performed such that the value of the index values of the travel information acquired using the vehicle information with many vehicles sold is high, and therefore, the main layer of the market can be advantageously evaluated, which enables evaluation in line with the market.

Since the tire information is included in the driving conditions, the tire information can be taken into consideration in evaluation of the driving severity number. In particular, the weighting is performed such that the value of the index values of the travel information acquired using the tire information with many tires sold is high, and therefore, the main layer of the market can be advantageously evaluated, which enables evaluation in line with the market.

Since the smartphone 1 is used as the client device 1, it is not necessary to prepare a dedicated device for acquiring the position information and the travel information, and the position information and the travel information can be easily acquired. Furthermore, since the position information can be acquired from the base station 10 of the smartphone 1 even in places such as tunnels or underground, where the satellite positioning system is difficult to use, the accuracy of the acquired position information can be improved.

In the evaluation of the driving severity number, correction based on the environmental information is performed. Since the driving severity number is largely affected by the environmental information, it is useful to be able to take the environmental information into consideration in the evaluation of the driving severity number.

Note that the present invention is not limited to the configurations described in the embodiment described above, and can be modified in various ways.

In the embodiment described above, an example has been described in which the wear amount of the tire is predicted based on the obtained travel information, but this is not limiting, and other information may be predicted. For example, the uneven wear amount of the tire may be predicted based on information such as when the vehicle travels on curves.

The evaluation of the driving severity number may be performed by extracting data having a specific attribute. As specific attributes, for example, the driving distance, the vehicle information, the tire information, and the environmental information may be used. In addition, data extraction conditions based on these specific attributes may be set by combining a plurality of attributes. For example, a driving distance that is a predetermined distance or more and a specific tire type may be used to extract data when the weather is fine in order to evaluate the driving severity number.

What is claimed is:

1. A vehicle driving condition evaluation method comprising:
dividing map information into a plurality of section areas;
acquiring a plurality of pieces of position information and travel information of a vehicle in association with each other;
storing the plurality of pieces of acquired position information and travel information;
calculating a plurality of index values related to a driving severity number for each of the section areas, based on the plurality of pieces of stored position information and travel information;
averaging the plurality of index values for each of the section areas; and
identifiably displaying an averaged index value as the driving severity number on a map displayed on a screen, wherein
weighting is performed on each of the plurality of index values according to a driving condition in averaging the plurality of index values for each of the section areas.

2. The vehicle driving condition evaluation method according to claim 1, wherein the driving condition for performing the weighting includes a driving distance.

3. The vehicle driving condition evaluation method according to claim 1, wherein the driving condition for performing the weighting includes vehicle information.

4. The vehicle driving condition evaluation method according to claim 1, wherein the driving condition for performing the weighting includes tire information.

5. The vehicle driving condition evaluation method according to claim 1, wherein the position information and the travel information are acquired from a mobile device installed in the vehicle.

6. The vehicle driving condition evaluation method according to claim 5, wherein
the mobile device is a smartphone, and
the position information is acquired from both a satellite positioning system and a base station of the smartphone.

7. The vehicle driving condition evaluation method according to claim 6, wherein the plurality of index values are corrected with environmental information of a place where the vehicle is located that is acquired by the smartphone over Internet.

8. A vehicle driving condition evaluation system comprising:
a receiving unit configured to detect position information of a vehicle;
a measuring unit configured to measure travel information of the vehicle;
a storage unit configured to store map information, a plurality of section areas obtained by dividing a map to be displayed on a screen based on the map information, and the position information and the travel information in association with each other;
a display unit configured to display a map based on the map information stored in the storage unit; and
a processing unit configured to, calculate a plurality of index values based on a plurality of pieces of the position information and the travel information stored in the storage unit, average the plurality of calculated index values for each of the section areas, and cause an averaged index value to be identifiably displayed as a driving severity number on the map displayed on the display unit, wherein
the processing unit performs weighting on the plurality of index values according to a driving condition in averaging the index values for each of the section areas.

9. The vehicle driving condition evaluation method according to claim 2, wherein the driving condition for performing the weighting includes vehicle information.

10. The vehicle driving condition evaluation method according to claim 2, wherein the driving condition for performing the weighting includes tire information.

11. The vehicle driving condition evaluation method according to claim 2, wherein the position information and the travel information are acquired from a mobile device installed in the vehicle.
